(19) United States
(12) Patent Application Publication
(10) Pub. No.: US 2017/0249660 A1
(43) Pub. Date: Aug. 31, 2017

(54) Methods and Apparatuses for Electronic Verification

(71) Applicants: Patricia Ann Smith, Lawrenceville, GA (US); Tavonia Tobia Evans, Snellville, GA (US)

(72) Inventors: Patricia Ann Smith, Lawrenceville, GA (US); Tavonia Tobia Evans, Snellville, GA (US)

(21) Appl. No.: 15/445,401

(22) Filed: Feb. 28, 2017

Related U.S. Application Data
(60) Provisional application No. 62/301,169, filed on Feb. 29, 2016.

(51) Int. Cl. G06Q 30/02; G06Q 50/00; G06K 19/06

(52) U.S. Cl. CPC G06Q 30/0248; G06K 19/06037; G06K 19/06028; G06Q 50/01

(57) ABSTRACT

A method implemented by an electronic verification system for verifying that an advertisement to engage in an activity is placed by a particular validated user whose identity is validated. The method comprises the electronic verification system receiving information that describes an advertisement to engage in an activity and that indicates when the particular validated user has or will place that advertisement. The method comprises creating referral information configured to be published in conjunction with the advertisement and to direct an advertisee to an electronic log of one or more advertisements placed by the particular validated user. The method comprises generating the electronic log to indicate when the particular validated user has or will place the advertisement described by the received information. The method comprises publishing the electronic log to be accessible in accordance with the referral information.

### RELATED APPLICATIONS

This application claims priority to U.S. Provisional Patent Application Ser. No. 62/301,169, filed Feb. 29, 2016, the entire contents of which are incorporated herein by reference.

### TECHNICAL FIELD

The present disclosure pertains to electronic verification, and particularly to verification that an advertisement is placed by a particular user.

### BACKGROUND

Advertisements to engage in an activity may be conveniently placed in ways that provide ready access to potential advertisees. A person may for example place a dating profile on a dating website to advertise that the person wants to go on a date. Or an advertiser may place a commercial advertisement in a print or an online advertisement listing to advertise that the advertiser wants to sell a good or service. But these types of advertisements often impose some degree of risk on the advertisee, because the advertisements may be placed anonymously or may have identifying information that is not validated. With the advertiser not validated in this way, the advertisee risks the advertiser not conducting the advertised activity in a way consistent with the advertisee's expectation. This proves particularly problematic for example when the advertised activity involves in-person contact with an unvalidated advertiser, since the advertisee risks his or her personal safety.

### SUMMARY

One or more embodiments herein are directed to a method implemented by an electronic verification system (EVS) for verifying that an advertisement to engage in an activity is placed by a particular validated user whose identity is validated. The method comprises receiving information that describes an advertisement to engage in an activity and that indicates when the particular validated user has or will place that advertisement. The method comprises creating referral information configured to be published in conjunction with the advertisement and to direct an advertisee to an electronic log of one or more advertisements placed by the particular validated user. The method comprises generating the electronic log to indicate when the particular validated user has or will place the advertisement described by the received information. The method comprises publishing the electronic log to be accessible in accordance with the referral information.

### BRIEF DESCRIPTION OF THE DRAWINGS

FIG. 1 shows a method according to one or more embodiments.

FIG. 2 shows advertisements according to one or more embodiments.

FIG. 3 shows an electronic log according to one or more embodiments.

FIGS. 4-8 show factors for determining a verification or credibility according to one or more embodiments.

FIG. 9 shows an electronic verification system according to one or more embodiments.

FIGS. 10-11 shows a method according to one or more embodiments.

FIG. 12 shows an electronic verification system architecture according to one or more embodiments.

FIG. 13 shows a method for self-verification according to one or more embodiments.

FIG. 14 shows a method for requesting a verification for a third party according to one or more embodiments.

FIG. 15 shows a method for reapplying for verification according to one or more embodiments.

FIG. 16 shows a method for sending a verification request to one or more third parties according to one or more embodiments.

FIG. 17 shows a method for accessing verification activity according to one or more embodiments.

FIG. 18 shows a method for converting a third party to a primary user according to one or more embodiments.

FIG. 19 shows a method for requesting an activity code according to one or more embodiments.

FIG. 20 shows methods for profile management according to one or more embodiments.

FIG. 21 shows methods for activity management according to one or more embodiments.

FIG. 22 shows method for viewing or deleting dashboard results according to one or more embodiments.

FIG. 23 shows method for performing verification activity according to one or more embodiments.

### DETAILED DESCRIPTION

One or more embodiments herein facilitate verification that an advertisement is placed by a particular user whose identity is validated. For example, one embodiment may facilitate verifying that an electronic advertisement for selling a vehicle was placed by the actual owner of that vehicle.

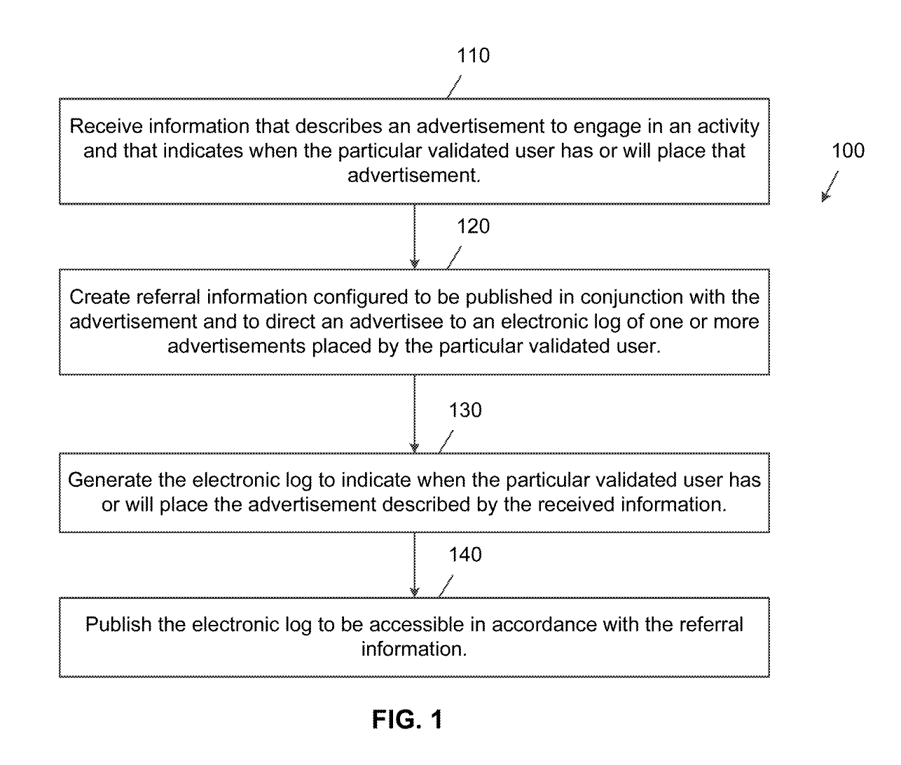

FIG. 1 illustrates a method 100 according to one or more embodiments in this regard. Specifically, FIG. 1 shows a method 100 for verifying that an advertisement to engage in an activity (e.g., to engage in a transaction for the sale of a vehicle) is placed by a particular validated user whose identity is validated (e.g., the validated owner of the vehicle). The method is implemented by an electronic verification system and comprises receiving information that describes an advertisement to engage in an activity and that indicates when the particular validated user has or will place that advertisement (Block 110). For example, the owner of the vehicle may provide the electronic verification system with the date and time that the owner has or will place the advertisement for a particular vehicle. Of course the information could be provided by another person or may be provided electronically by the website where the owner uploads the advertisement.

The method also comprises creating referral information configured to be published in conjunction with the advertisement and to direct an advertisee to an electronic log of one or more advertisements placed by the particular validated user (Block 120). Where the referral information is a Quick Response (QR) code for instance, the owner of a vehicle may publish this QR code with the advertisement prior to or after uploading the advertisement.

The method further comprises generating the electronic log to indicate when the particular validated user has or will place the advertisement described by the received information (Block 130).

The method finally comprises publishing the electronic log to be accessible in accordance with the referral information (Block 140). In some embodiments, for instance, this electronic log is published on a webpage or portal accessible at an address encoded by referral information in the form of a QR code.

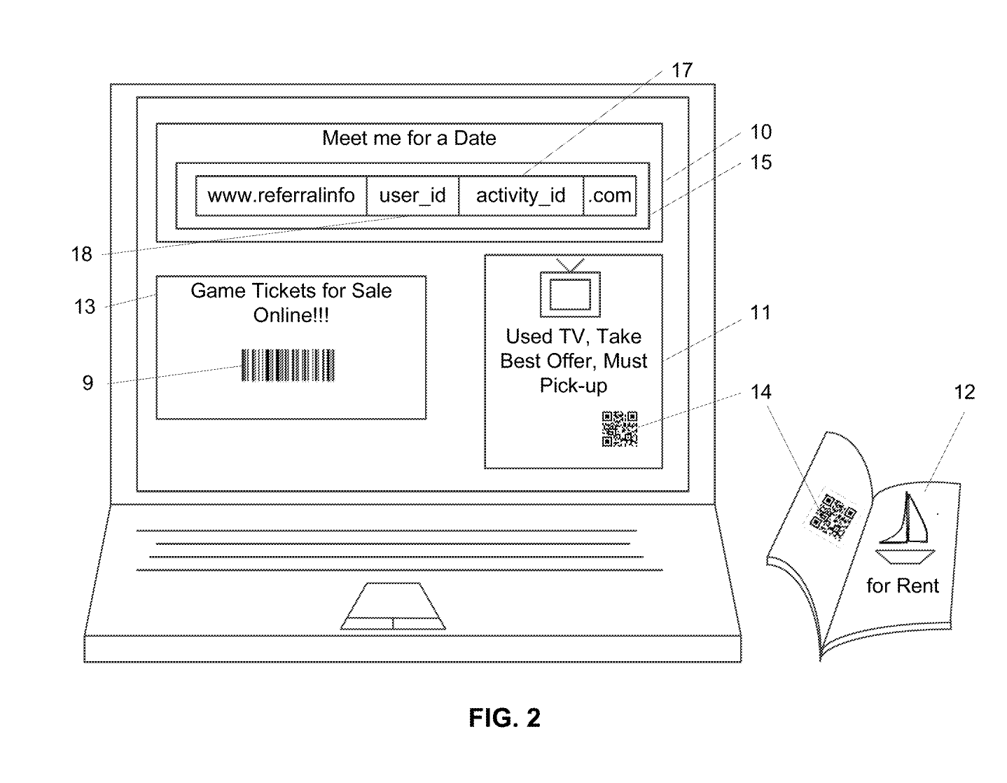

FIG. 2 depicts example advertisements according to one or more embodiments. In one or more embodiments, the advertisement is an advertisement to engage in an activity in person with the particular validated user (e.g., dating advertisement 10, television advertisement 11, and vehicle advertisement 12). In the same or different embodiments, the advertisement is an advertisement to engage in a financial transaction in person with the particular validated user (e.g., television advertisements 11 and vehicle advertisement 12). In the same or different embodiments, the advertisement is an advertisement to engage in a social activity in person with the particular validated user. For example, the advertisement is a dating website and the social activity is a date (e.g., advertisement 10). Of course the advertisements could be used for advertisements that will not result in an in person meeting,

In one or more embodiments, the advertisement is an online advertisement (e.g., advertisements 10, 11 and 13). In different embodiments the advertisement is placed in a print source such as a newspaper or magazine (e.g., advertisement 12).

In one or more embodiments, the advertisement is published with referral information. The referral information in one or more embodiments comprises a Quick Response (QR) code 14. In the same or different embodiments, the referral information comprises a uniform resource locator (URL) 15. In the same or different embodiments, the referral information comprises a barcode 9. In the same or different embodiments it is an image embedded with referral information.

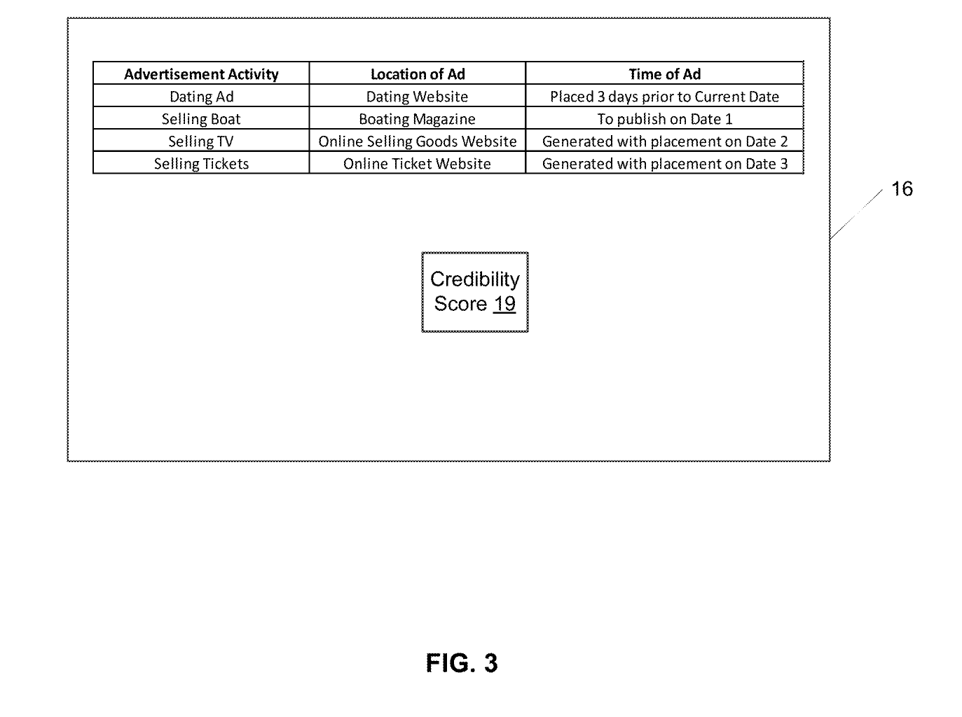

In one or more embodiments, the referral information directs an advertisee to an electronic log 16 maintained by an electronic verification system. FIG. 3 depicts an example electronic log 16 that includes a log of advertisements placed by a particular validated user for the advertisements of FIG. 2.

In one or more embodiments, the method implemented by the electronic verification system comprises receiving information that describes an advertisement (e.g., advertisements 10-13). For instance, the received information indicates a location (e.g., website) where the particular validated user has or will place the advertisement. In one or more embodiments the electronic log 16 comprises received information that describes an advertisement.

In one or more embodiments, the method implemented by the electronic verification system comprises creating the referral information based on at least some of the received information. For instance, as shown in FIG. 2, the advertisement activity could be associated with a unique activity identifier 17 that is used in the URL 15. The referral information could include multiple ones of the received information or other information generated by the electronic verification system. For instance, the referral information could include a user identifier 18 that is either received by the electronic verification system (e.g., input by the user) or generated uniquely by the electronic verification system when a user registers with the system.

In one or more embodiments, the activity identifier 17 is created by the systems that an advertiser uses to create or place the advertisements, profiles, etc. For activity that does not result in a unique identifier (e.g., a printed advertisement12) one or more embodiments generate an activity identifier to associate with the logged activity. In the same or different embodiment, the advertiser captures the activity identifier and combines it with other information (e.g., a user email address, phone number, or EVS unique identifier for their validated identity) to create referral information to point back to an electronic verification system.

In one or more embodiments, the method further comprises establishing a degree to which the particular validated user is credible, and associating that degree with the generated electronic log. For instance, as shown in FIG. 3, the electronic log includes a credibility score 19.

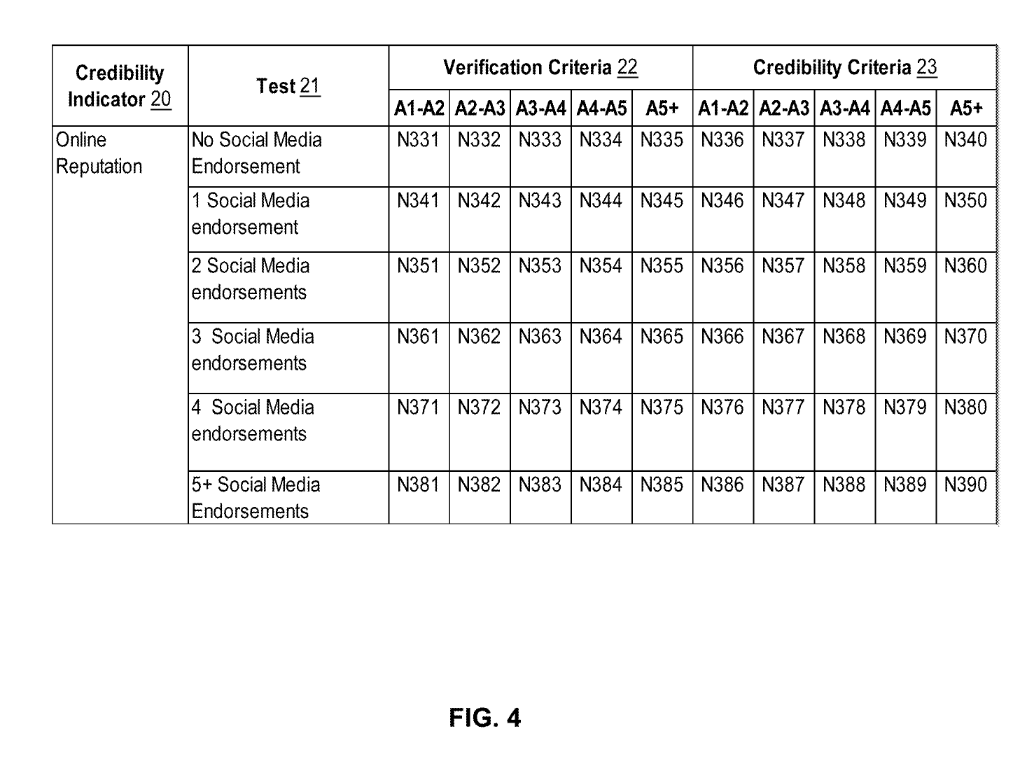

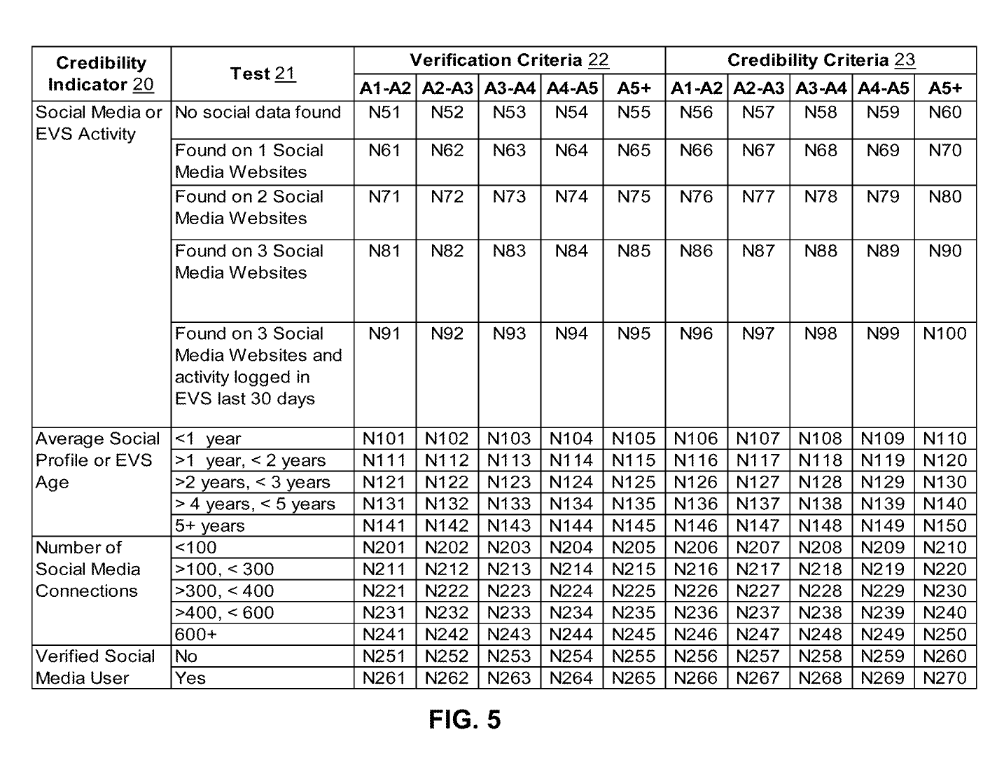

Establishing the degree to which the particular validated user is credible may comprise determining a quantitative credibility score based on a plurality of factors. For instance, FIGS. 4-8 depict various credibility indicators 20 with factors or tests 21 for determining a credibility score 19 according to one or more embodiments. A credibility score could be determined from a single credibility indicator as shown in FIG. 4 or multiple indicators as shown in FIG. 5. The score could be determined by adding up credibility criteria 23 associated with a particular test outcome.

In one or more embodiments, the method further comprises receiving information indicating one or more online activities of the particular validated user and establishing the degree to which the particular validated user is credible based on the indications indicating the one or more online activities. For instance, as shown in FIG. 4, online reputation may be a credibility indicator 20 for determining a credibility score 19, and the test 21 for online reputation could be based on online activity factors (e.g. the amount of endorsements on a social media website liked Linked In).

Establishing the degree to which the particular validated user is credible may comprise determining a quantitative credibility score based on weighting a plurality of factors. The plurality of factors may be weighted differently depending on an age of the particular validated user. For instance, as shown in FIG. 4 the verification criteria 22 has different age categories with different number scores depending on where a user falls in an age range. If combined with other credibility indicators 20, there could be a single or different weighting for the score relative to other credibility indicators derived based on the factors or tests 21 associated with a particular indicator 20.

The plurality of factors may include how long and/or an extent to which the particular validated user has previously engaged in certain online activities. For example, as shown in FIG. 5, the indicators 20 could comprise average time on a social media profile or the electronic verification system (EVS). If the advertiser has more than one social media profile, the ages of all the profiles can be divided by the number of profiles to determine an average age.

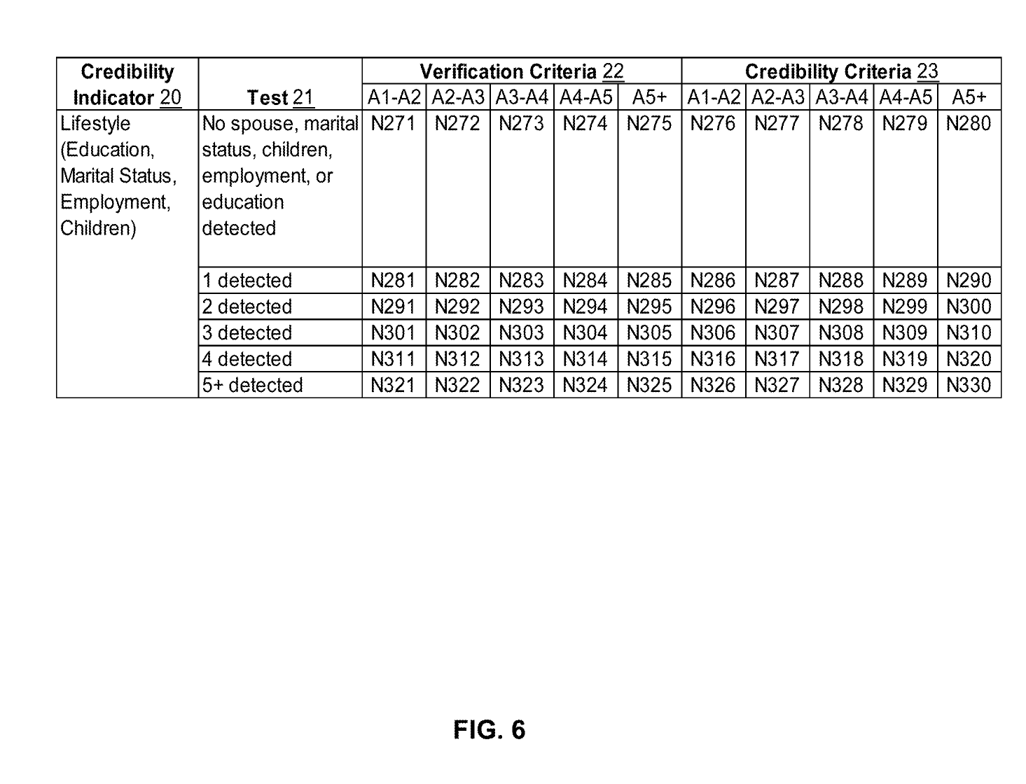

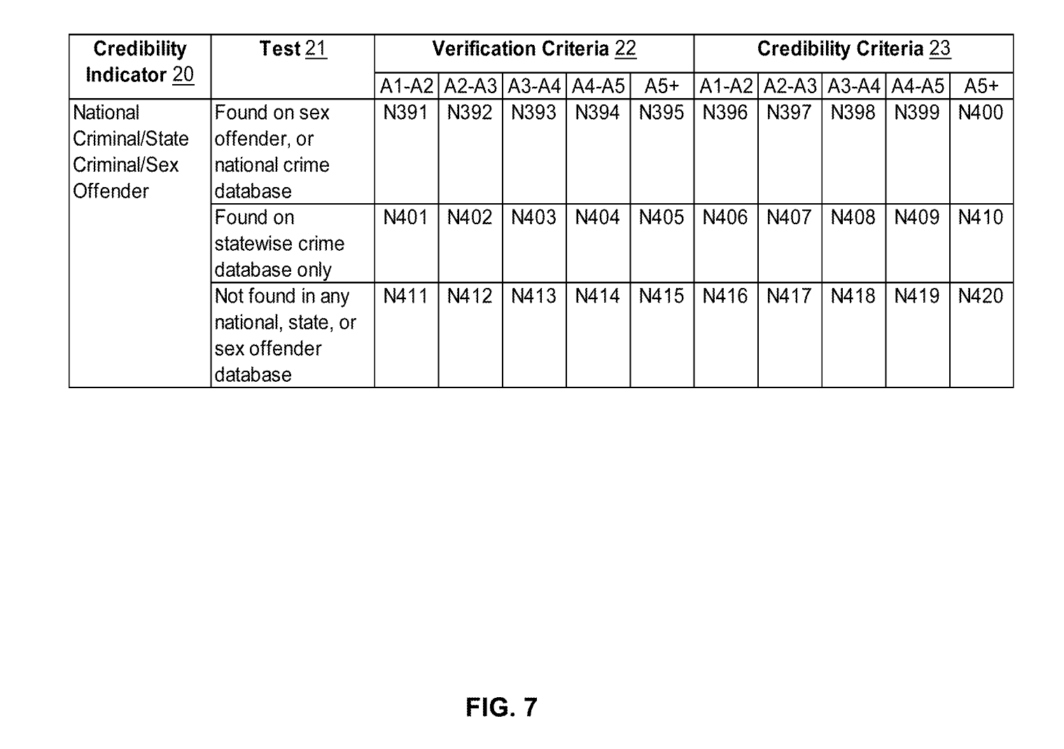

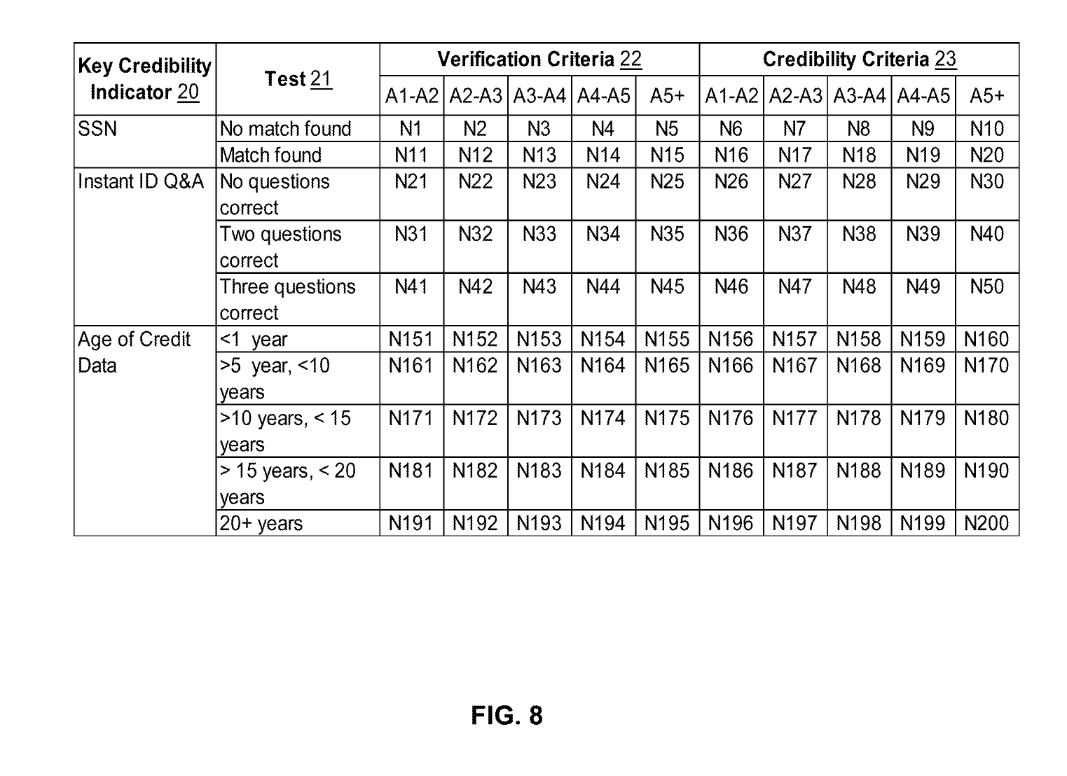

Alternatively or additionally, the plurality of factors may include an extent to which the particular validated user is socially connected. This could be derived from online activity as shown in FIG. 5. For instance, online activity could include the number of connections on Linked In or number of friends on Facebook another social media website. Alternatively or additionally, the plurality of factors may be derived from offline activities as shown in FIG. 6. Alternatively or additionally, the plurality of factors includes an extent to which the particular validated user has a criminal history as shown in FIG. 7. The factors could be derived from verifying data provided by the advertiser or a credit history of the advertiser as shown in FIG. 8.

A credibility score could be derived from all of the credibility indicators 20 in FIGS. 4-8 or individual credibility indicators from these Figures. FIGS. 4-8 are merely examples of possible credibility indicators for determining a credibility score. More or different credibility indicators could be used.

One or more embodiments provide a solution for establishing the identity, credibility, and substance of an internet user based on a number of factors, including their past online and offline activity. The solution also allows a validated user to catalog new online and offline activity to protect them from identity theft and to continue to enhance their profile as a credible online user.

An algorithm can be used to weight factors in determining the credibility of a validated user. For example a 10-Point Credibility Algorithm, which uses ten (10) weighted key credibility indicators 20 from FIGS. 4-8, can be used. Of course those of ordinary skill in the art will appreciate more or less factors can be used, and they may include one or more factors described herein or one or more different factors.

Credibility indicators 20 and their associated factors or test 21 can be organized into categories including Identity, Longevity, Substance, Reputation and Background. For example, SSN and Instant ID Q&A could be in a category of identity. Internet Activity or Social Profile Information, such as Social Media Activity could be under Longevity as well as Credit information, such as age of credit data. Verified social media information such as number of Facebook friends or lifestyle information could be in a category of substance. Background could include criminal history. Online reputation could be in a Reputation category. One or more factors may be in different categories. Factors within a category or the categories themselves can be weighted differently to determine a credibility score.

Factors could include the following indicators: SSN Origination Match, Lexis Nexis Instant ID Q&A, Logged Internet Activity, Social Profile Age, Age of Credit Data, Number of Social Media Friends/Connections, Online Self-Verification, Lifestyle, and/or Criminal Background Check Status as well in FIGS. 4-8.

In one or more embodiments the method further comprises receiving information for verifying whether the user is a real person (e.g., determining a probability that an advertiser is a real person). For instance the verification result may have different colors based on adding up verification criteria 22 associated with relevant test outcomes to determine a verification score. Table 1 shows a color scheme in accordance with one or more embodiments for displaying a verification result. Each color is associated with a particular verification score or range of scores.

TABLE 1
Verification Result

| | SPECTRUM | | |
|---|---|---|---|
| No. | COLOR | MEANING | STATUS |
| 1. | Dark Red | Not a Real Person | Not Verified |
| 2. | Light Red | A Real person with | Verified |
| | | serious issues found in | |
| | | the verification process | |
| 3. | Yellow | A Real person but | Verified |
| | | proceed with caution. No | |
| | | serious issues found in | |
| | | the verification process | |
| 4. | Blue | A Real person with no | Verified |
| | | issues but with limited | |
| | | digital footprint | |
| 5. | Dark Green | A Real person with no | Verified |
| | | issues found and sufficient | |
| | | digital footprint | |

The displayed credibility score or image may have different colors to represent the verification score. The credibility score or image is associated with an online or offline activity with a verified user's identity. Alternatively, the verification score could be a different image separate from the credibility image. Alternatively, there could be a displayed number value for the verification score and the credibility score could have different colors based on the extent of credibility.

As shown in FIGS. 4-8, a certain number value (e.g., N1-N420) can be associated with a test outcome for an individual factor. For example, as show in FIG. 8 the credibility indicator 20 of a social security number (SSN) could have a match found or no match found for an aspect related to a provided social security number. The number values for a given factor or outcome for a factor may be the same or different for different age ranges and for different types of scores. For example, a given factor or criteria, e.g., social media activity, may have a low or zero value when weighted to determine a verification score, but a higher value for credibility score. Values for a particular outcome and/or factor within a particular score may increase or decrease with age or may have one or more peaks (e.g., at a younger age, middle age, or older age). For example, social media data may be more or less relevant for a younger age group based on the likelihood they would use a particular social media for a particular amount of time as compared to an older user. Those or ordinary skill in the art will appreciate that there could be more or less age ranges and more or less outcomes for an individual factor including just one outcome for an individual factor.

One or more embodiments herein include an electronic verification system for verifying that an advertisement to engage in an activity is placed by a particular validated user whose identity is validated. The electronic verification system comprises a communication interface circuit configured to receive information that describes an advertisement to engage in an activity and that indicates when the particular validated user has or will place that advertisement. The electronic verification system comprises one or more processing circuits. The processing circuit(s) are configured to create referral information configured to be published in conjunction with the advertisement and to direct an advertisee to an electronic log of one or more advertisements placed by the particular validated user. The processing circuit(s) are configured to generate the electronic log to indicate when the particular validated user has or will place the advertisement described by the received information. The processing circuit(s) are configured to publish the electronic log to be accessible in accordance with the referral information.

In one or more embodiments, the electronic verification system verifies an advertisement as described herein.

In one or more embodiments, the communication interface circuit is configured to receive information by receiving information that indicates a location where the particular validated user has or will place the advertisement.

In one or more embodiments, the processing circuit(s) are configured to create the referral information based on at least some of the received information.

In one or more embodiments, the processing circuit(s) are configured to create referral information by determining a QR code and/or a URL.

In one or more embodiments, the processing circuit(s) are configured to establish a degree to which the particular validated user is credible, and associate that degree with the generated electronic log.

In one or more embodiments, the communication interface circuit is configured to receive information indicating one or more online activities of the particular validated user and the processing circuit(s) are configured to establish the degree to which the particular validated user is credible based on the indications indicating the one or more online activities.

In one or more embodiments, the processing circuit(s) are configured to establish the degree to which the particular validated user is credible by determining a quantitative credibility score based on weighting a plurality of factors.

In one or more embodiments, the plurality of factors include one or more types of factors described herein.

In one or more embodiments, the processing circuit(s) are configured to weight the plurality of factors differently depending on an age of the particular validated user.

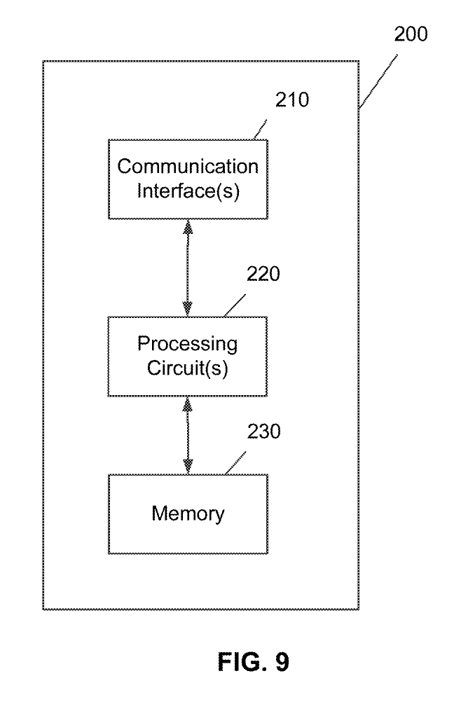

FIG. 9 shows an example electronic verification system 200. One or more apparatuses of the electronic verification system comprise functional means or units, to implement the processing described above. In one or more embodiments, the apparatus(es) comprise one or more processing circuits (220) configured to implement the above processing, such as by implementing corresponding functional means or units. In one embodiment, for example, the apparatus(es) processing circuit(s) implement functional means or units as respective circuits. The circuits in this regard may comprise circuits dedicated to performing certain functional processing and/or one or more microprocessors in conjunction with memory. In embodiments that employ memory (230), which may comprise one or several types of memory such as read-only memory (ROM), random-access memory (RAM), cache memory, flash memory devices, optical storage devices, etc., the memory stores program code that, when executed by the one or more for carrying out one or more microprocessors, carries out the techniques described herein. In one or more embodiments, received information is stored at the same or different databases. The system may include for instance a communication means or unit such as the communication interface(s) 210 for receiving information related to an advertisement described herein.

Embodiments herein include a computer program product stored on a non-transitory computer readable medium. The computer program product comprises computer program code that, when executed by an electronic verification system, verifies that an advertisement to engage in an activity is placed by a particular validated user whose identity is validated. The computer program code configures the electronic verification system to receive information that describes an advertisement to engage in an activity and that indicates when the particular validated user has or will place that advertisement. The computer program code configures the electronic verification system to create referral information configured to be published in conjunction with the advertisement and to direct an advertisee to an electronic log of one or more advertisements placed by the particular validated user. The computer program code configures the electronic verification system to generate the electronic log to indicate when the particular validated user has or will place the advertisement described by the received information. The computer program code configures the electronic verification system to publish the electronic log to be accessible in accordance with the referral information.

The computer program code configures the electronic verification system to perform any of the methods described herein.

One or more embodiments prove useful for online and offline activities that have a certain level of anonymity. For instance, there are almost endless number of medium available to consumers for initiating peer-to-peer personal and business interactions, both online and offline because people use the internet for many aspects of life, both business and personal. For instance, Craiglist is a website people use to provide classified advertisements for goods and personal interactions. More than ever before it is harder to know that anyone we encounter as a result of these interactions is who they say they are or is even a real person, and if the advertisee will be physically harmed or scammed by the advertiser.

An electronic verification system as described herein can be positioned as a solution to the problem of anonymity online; consumers who wish to transact with strangers will leverage the electronic verification system to distinguish themselves from those who would use websites like Craigslist.com or dating sites to find unsuspecting victims. People buy and sell products and services online and offline, date and network online and conduct business online. Meeting people contacted via the internet is not always safe, and it is hard to know who to trust.

There is also currently not an easy, comprehensive, data-driven mechanism for voluntarily pronouncing that you as an individual are legitimate and can be trusted. Alternative solutions require the consumer to perform background checks, using information from a variety of providers. These checks are often expensive and rely on public record information that is often incomplete or inconclusive when it comes to identifying and assessing the character of an individual. Further, the fluid and fast paced nature of the internet and the many activities that often result in face-to-face interactions with strangers make these traditional forms of background checks cumbersome and impractical (e.g., for an individual transaction) and are controlled by the advertisee and not the advertiser.

More than ever before, the vast array of data available online about specific individuals has given rise to identity theft, and profile spoofing—the practice of using available images and personal information to create fake profiles, ads, or other online artifacts for the purpose of defrauding or otherwise fooling unsuspecting individuals into taking some action that benefits the perpetrator. Social media accounts (e.g., Facebook) can be plagued by online scammers who use the information from existing user profiles to create fake accounts, which they then use to contact innocent users to defraud them in some way. Because there is a limited ability on the most popular social networks to truly validate ones identity, these fraudsters are free to commit such fraudulent activity unchecked.

One or more embodiments allow individual internet users to validate their identities in a way that confirms that they are who they say they are, by collecting and confirming validating information that is reconfirmed in periodic intervals. In the same or different embodiments, users can log online or offline activity to associate with that validated identity that can be easily displayed on a variety of online and offline medium. In the same or different embodiments, an individual who is considering participating in an online or offline transaction with users of an electronic verification system as described herein can access information that will verify the origin and validated user who initiated the activity.

In the same or different embodiments, an electronic verification system accordingly allows individuals to voluntarily validate and document both their identity and their record of on and offline activity in a way that builds a credibility index that in some ways mirrors the credit file information that provides the input into a FICO or BEACON score, for example. In the same or different embodiments it is a platform for self-certification and internet activity management that leverages a number of data stores and identity data points to provide a solid level of accuracy for both identifying an individual and evaluating their level of credibility based on a number of key factors. Tying that validation to internet activity greatly increases the probability that online transactions, interactions, etc., can be conducted as safely as possible. In one or more embodiments, a unique combination of public record, social graph and other data repositories is used to validate an identity and length-of-time information to establish credibility, and then ties activities online to that verified, credible identity.

One or more specific embodiments are described below that are the same or different from embodiments described above and are used to provide specific examples and not to limit any embodiments described above.

An electronic verification system according to one or more embodiments is used in different advertisement situations. For example the system is used by a buyer (e.g., the buyer wants to buy something online and needs to verify that the person I am buying from is real and to get a sense that it is safe to do business with this person). In the same or different embodiments, the system is used by a seller (e.g., the seller wants to sell something online and wants to assure my buyer that I am real and safe to do business with). Alternatively or additionally, the electronic verification system is used by an online Dater (e.g., the dater is on a dating site and looking to meet someone. The dater feels much better knowing that a profile on a dating website is associated with a real person and has an online or offline history that makes the dater feel safe about meeting the person associated with the profile. Alternatively or additionally, the electronic verification system is used by a service provider (e.g., the service provider is a nanny giving a potential employer a sense that the nanny is safe to hire in an online profile). Alternatively or additionally, the electronic verification system is used by an employer of a service provider (e.g., the service provider is looking for care for his elderly mother and needs to get assurance that a potential caregiver has been verified as being real and has a history that makes the service provider feel safe). Alternatively or additionally, the electronic verification system is used by an employer (e.g., the employer is looking to hire an accountant and wants to verify a potential candidate's identity).

One or more embodiments provide systems, methods, and a machine implemented set of processes for allowing a user to associate online and offline activity with a user profile that represents the self-certified identity of the profile owner. It is an objective of one or more embodiments to allow individuals to use a system generated barcode to access details regarding the logged activity along with information that provides proof that the initiating user is who they say they are. In one embodiment, a web system is implemented that allows the user to enter specific information regarding their online or offline activity in order to generate a unique identifier and barcode image that is associated with their validated identity. This barcode can be used in advertisements, on profiles, etc., to automatically direct the user to the system of record for the validated and logged information.

In an example embodiment, a user accesses a website, and self-certifies by answering a few brief questions and provides basic identity information. Once they have a profile with the electronic verification system, they can begin managing their online activity. For example, the person could create a record of an advertisement (e.g. an advertisement that has been or will be posted to Craigslist website). The electronic verification system will generate an encoded image that the person can upload to the advertisement that shows the person is certified. The information that the person provides when creating the record of the ad (date and time ad placed, etc.) would prevent another user from attempting to use the encoded image on an advertisement other than the one associated with it. One or more embodiments would also allow for an advertisee to buy third party certifications for anyone the advertisee was considering doing business with in response to advertisement (e.g., on Craigslist or any other classified ads or dating site).

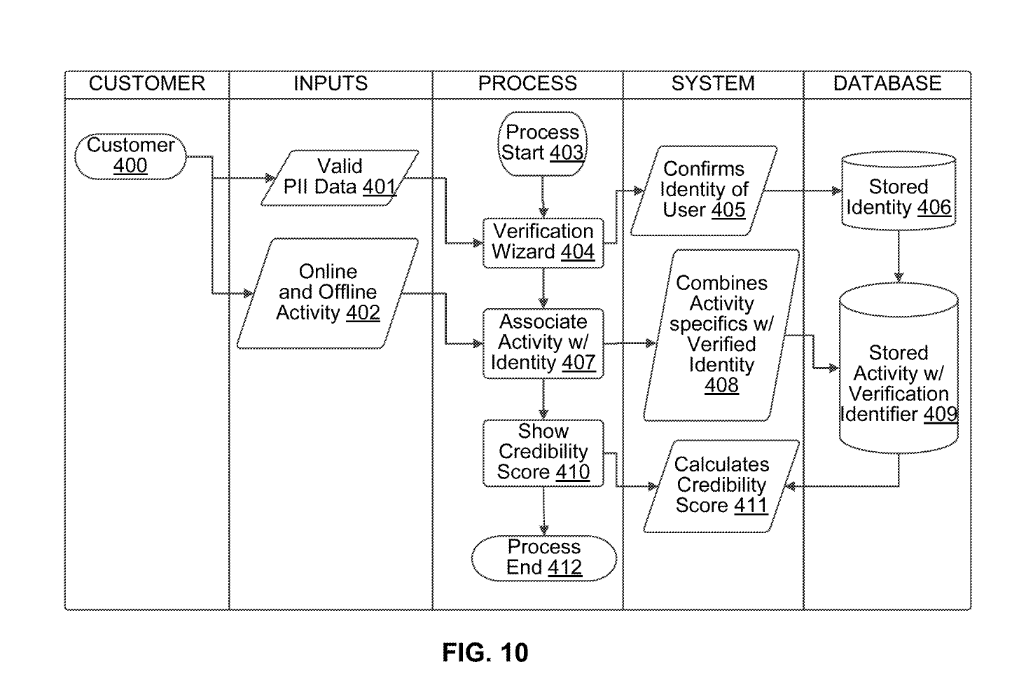

An example transaction is described with reference to FIG. 10. A User 1 (customer 400) creates a profile and answers, for example, questions the user would uniquely know by inputting valid personal identifying information (PII) data at step 401. The electronic verification system begins a verification process at step 403 and verifies the accuracy of that information at step 404, and establishes an electronic verification system status. In one or more embodiments, information verified includes one or more of a government identification (e.g. a social security number or driver's license), social media identity, credit or employment history, and criminal background. The electronic verification system confirms the identity of a user at step 405 and stores the identity in step 406.

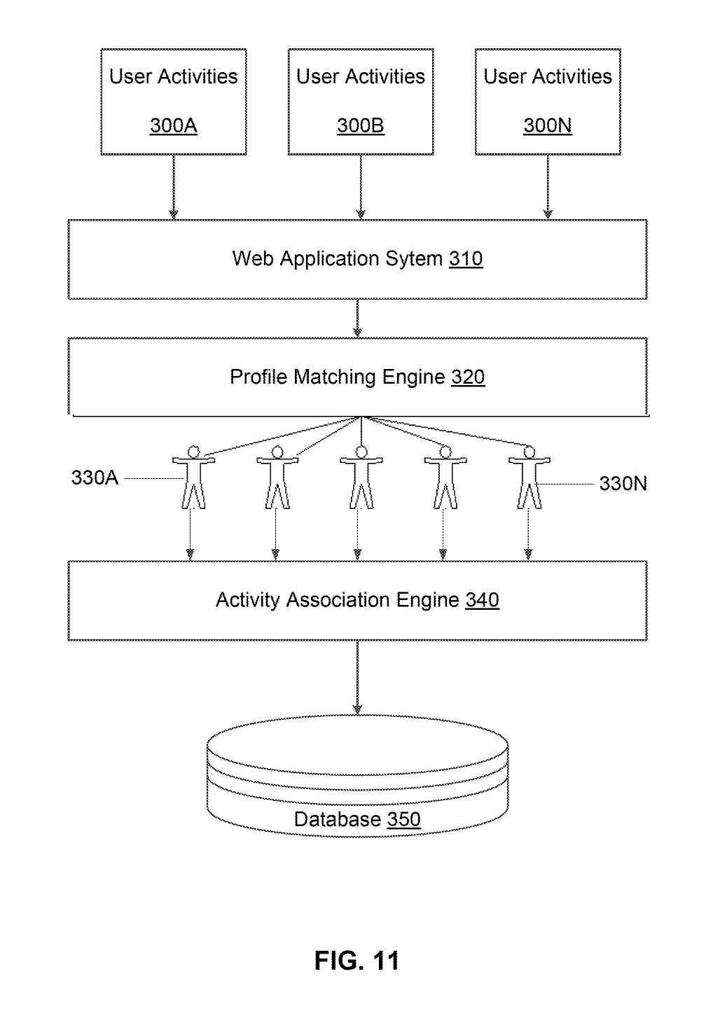

Once the user has created a profile or simultaneously with creating a profile as show in FIG. 10, the user can log online and offline activities in step 402. Activities include anything that builds a footprint online and offline and helps in the overall verification process (e.g., placing online or offline classified advertisements, dating profiles, and social media profiles. For instance as shown in FIG. 11, the electronic verification system 200 comprises a web application system 310 for receiving user activities 300. The activities are associated with the verified identity at step 407 and combined with the verified identity at step 408. The activities are stored with a verification identifier for the stored identity at step 409.

User 1 initiates or continues the process to establish a credibility rating. The stored activity with verification identifier is used to calculate a credibility score at step 411, and the credibility score is displayed with the user account at step 410, ending the process of creating a profile at step 412, logging activities, and creating a credibility score. The electronic verification system establishes an electronic verification system status and credibility rating using a credibility algorithm and credibility indicators as described herein.

FIG. 11 shows a particular application system for associating input user activities with a profile. The web application system 310 sends the user activities to a profile matching engine 320 for associating with a particular user profile 330, and associates that activity with profile in the activity association engine 340. The associated activity can then be stored in a database 350.

User 1 places an advertisement or creates a profile on the internet by coping the unique URL or identifier for a particular advertisement or profile. The electronic verification system uses the unique identifier and the date/time stamp to generate an encoded image. User 1 uploads the encoded image to their profile or advertisement.

User 2 encounters the profile or advertisement created by User 1 and scans the image to access information in the system to confirm his or her identity. User 2's action causes the electronic verification system to retrieve the identity and internet activity verification information and display it.

One or more embodiments use ten (10) weighted key credibility indicators within the following five categories to establish 1) a verified status such as that the user is safe to meet and 2) a Credibility Rating for each individual user.

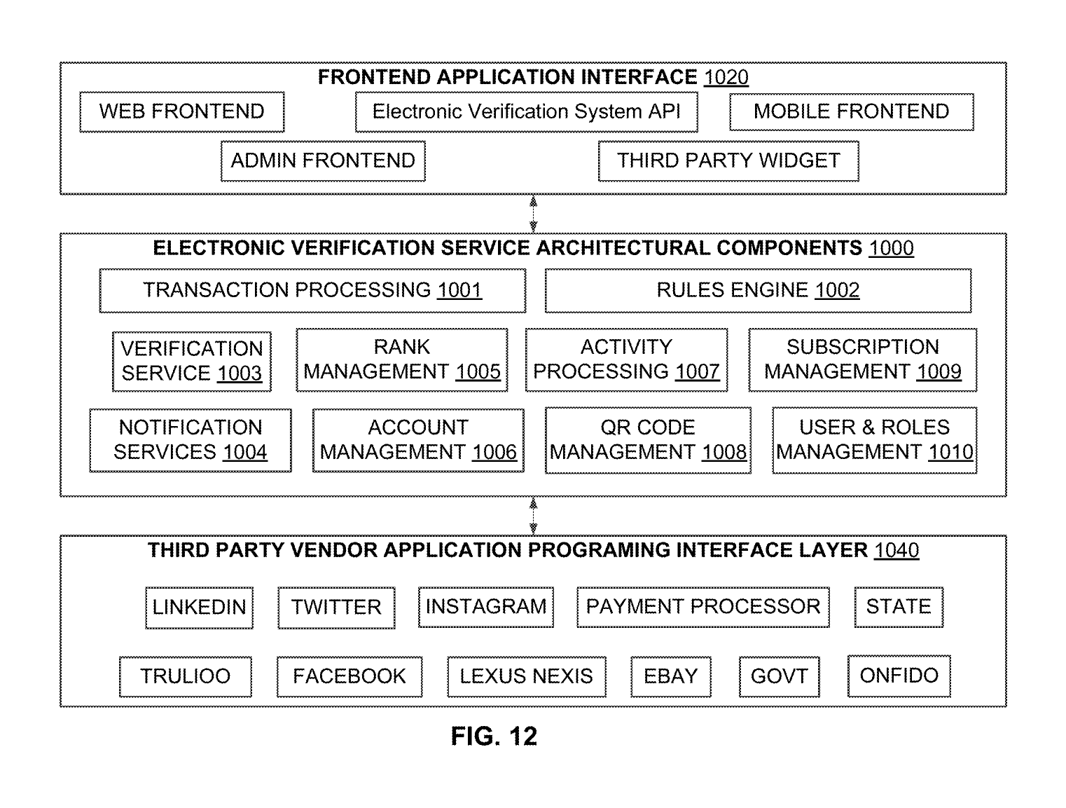

FIG. 12 depicts example architecture components 1000 for an electronic verification system according to embodiments herein that transmits and receives information from a frontend application interface 1020 for the electronic verification system. The architecture components 1000 also receive information from a third party vender application programming interface (API) layer 1040. For instance, the architecture components receive or transmit this information via the communication interface(s) 210 of electronic verification system 200 of FIG. 9.

The architecture components 1000 include one or more of a transaction processing unit 1001, rules engine unit 1002, verification service unit 1003, notification services 1004, rank management unit 1005, account management unit 1006, activity processing unit 1007, QR code management 1008; subscription management 1009, user and roles management (admin) unit 1010.

The transaction processing unit 1001 processes all the transactions across the various services of the electronic verification system platform.

The rules engine unit 1002 determines the verification results (e.g., once the results come from the third party sources).

The verification service unit 1003 processes verification across one or more third party vendors and retrieves the results.

The notification services unit 1004 is responsible for all notifications on the platform including customer, admin and partner notifications from web, mobile, SMS, and e-mail.

The rank management unit 1005 maintains and manages rank updates based upon activity (e.g., for monthly subscribers of the electronic verification system, the ranks get reworked and updated based upon the subscribers activity).

The account management unit 1006 performs standard user account and profile management. For users that have a subscription, an account with user-id and password is created for the user, and the user is able to see information pertaining to when the user logs in via the frontend application interface 1020.

The activity processing unit 1007 logs online and offline activities that serves as input into the user ranking.

The QR code management unit 1008 generates QR codes as part of the activity logging.

The subscription management unit 1009 manages all types of subscriptions on the platform. Based on the type of subscription, a user is granted access to data stored by the electronic verification system.

The user and roles management (admin) unit 1010 determines who the users are and what they can see.

In one or more embodiments, these units and interfaces for receiving or transmitting information from a frontend application interface and a third party vendor API layer are implemented by the processing circuits 220. These units can be implemented by the processing circuits 220 as one unit or separate units.

In one or more embodiments, the electronic verification system is useful in one or more of three use cases: (1) Use Case 1.0: Log Online Activity in Electronic Verification System; (2) Use Case 2.0: Log Offline Activity in Electronic Verification System; and (3) Use Case 3.0: Scan QR Code to Verify Activity (Third party/peer user).

In one or more embodiments in accordance with use case 1.0, a user creates activity in log and generates a QR Code to represent online activity. The user has a profile in the electronic verification system and current self-certification. The success end condition is the system creates a QR Code and associates it with the newly logged activity, and the fail end condition is if the system cannot generate a QR Code.

The user's action and electronic verification system response will be described in more detail below for a user in accordance with use case 1.0 in one or more embodiments is shown in Table 2 below:

TABLE 2

| User Action | | | System Response |
|---|---|---|---|
| 1.1 | Logs in to Safe2Meet | 1.1.1 | Verifies credentials and displays |
| | Account | | Account Navigation |
| 1.2 | Selects ‘Log Activity’ | 1.2.1 | Prompts user to enter activity |
| | | | information |
| | | 1.2.1.1 | URL or unique identifier for site |
| | | | posting/ad/profile/other activity |
| | | | (when available) |
| | | 1.2.1.2 | Title of posting/ad/profile/other |
| | | | activity |
| | | 1.2.1.3 | Email address associated with |
| | | | posting/ad/profile/other activity |
| | | | (required |
| | | 1.2.1.4 | Choose activity site or enter new |
| | | | activity |
| | | 1.2.1.5 | Phone number associated with |
| | | | posting/ad/profile |
| | | 1.2.1.6 | Date and Time posting/ad/profile |
| | | | created (system generated) |
| 1.3 | Clicks ‘Submit’ | 1.3.1 | System saves activity information |
| | | 1.3.1 | System generates unique identifier |
| | | | number for posting/ad/profile/other |
| | | | activity |
| | | 1.3.2 | System creates QR Code with |
| | | | embedded URL that includes |
| | | | domain name/user ID/unique |
| | | | identifier of logged activity |
| | | 1.3.3 | Displays ‘Thank you. Your activity |
| | | | has been successfully logged |
| | | 1.3.4 | Presents QR Code image to user for |
| | | | download |

In one or more embodiments in accordance with use case 2.0, a user creates a log of activity and generates a QR Code to represent offline activity. The user has a profile and current self-certification. The success end condition is the system creates a QR Code and associates it with the newly logged activity, and the fail end condition is if the system cannot generate a QR Code.

The user's action and electronic verification system response will be described in more detail below for a user in accordance with use case 1.0 in one or more embodiments is shown in Table 3 below:

TABLE 3

| User Action | | System Response | |
|---|---|---|---|
| 2.1 | Logs in to Safe2Meet | 2.1.1 | Verifies credentials and displays |
| | Account | | Account Navigation |
| 2.2 | Selects ‘Log Activity’ | 2.2.1 | Prompts user to enter activity |
| | | | information |
| | | 2.2.1.1 | Title of offline activity |
| | | 2.2.1.2 | Email address associated with |
| | | | offline activity (required) |
| | | 2.2.1.3 | Choose activity site or enter new |
| | | | activity |
| | | 2.2.1.4 | Phone number associated with |
| | | | offline activity |
| | | 2.2.1.5 | Date and Time offline activity log |
| | | | created (system generated) |
| 2.3 | Clicks ‘Submit’ | 2.3.1 | System saves activity information |
| | | 2.3.1 | System generates unique identifier |
| | | | number for offline activity |
| | | 2.3.2 | System creates QR Code with |
| | | | embedded URL that includes |
| | | | domain name/user ID/unique |
| | | | identifier of logged activity |
| | | 2.3.3 | Displays ‘Thank you. Your activity |
| | | | has been successfully logged |
| | | 2.3.4 | Presents QR Code image to user |
| | | | for download |

In one or more embodiments in accordance with use case 3.0, an external user encounters a badge (e.g., a QR code) on an online or offline activity and scans the QR code to verify activity of a third party or peer user. The activity (post/ad/profile) has been logged in to the electronic verification system. The success end condition is the system displays activity detail based on the embedded URL from the QR code, and the fail end condition is if the system cannot display activity details.

The user's action and electronic verification system response will be described in more detail below for a user in accordance with use case 1.0 in one or more embodiments is shown in Table 4 below:

TABLE 4

| User Action | | System Response | |
|---|---|---|---|
| 3.1 | User uses any | 3.1.1 | System displays details about |
| | QR Code | | the activity owner and the |
| | reader to scan | | activity detail |
| | advertisement's | 3.1.1.1 | Username, Age of Profile, |
| | QR code | | Electronic Verification Service |
| | | | Certification Status, Activity |
| | | | Title, Activity Logged Date, |

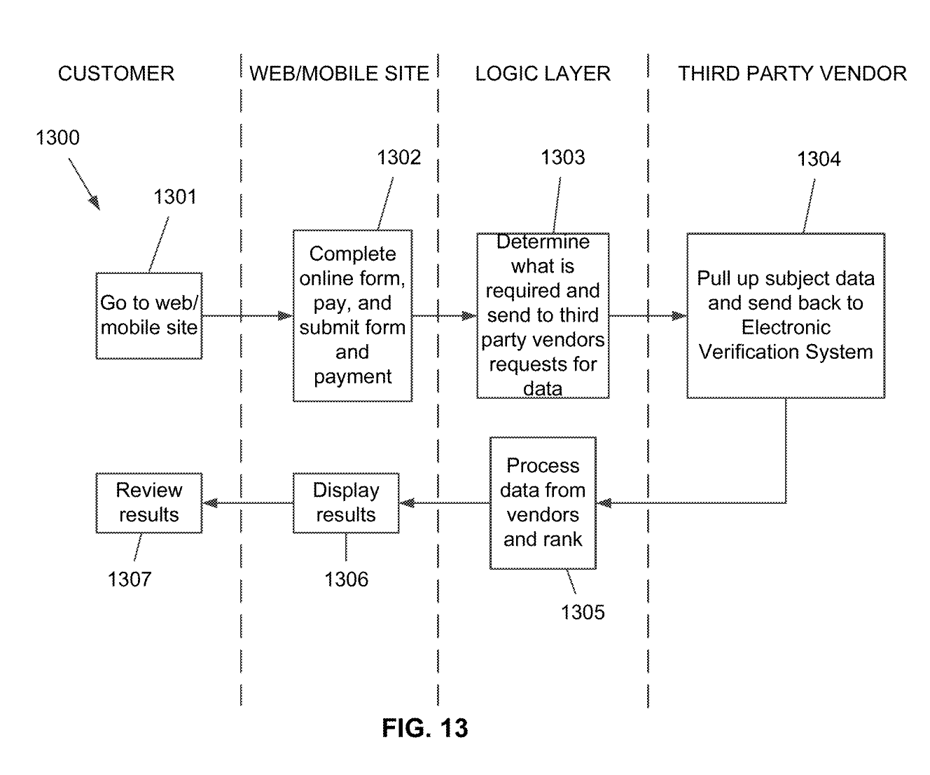

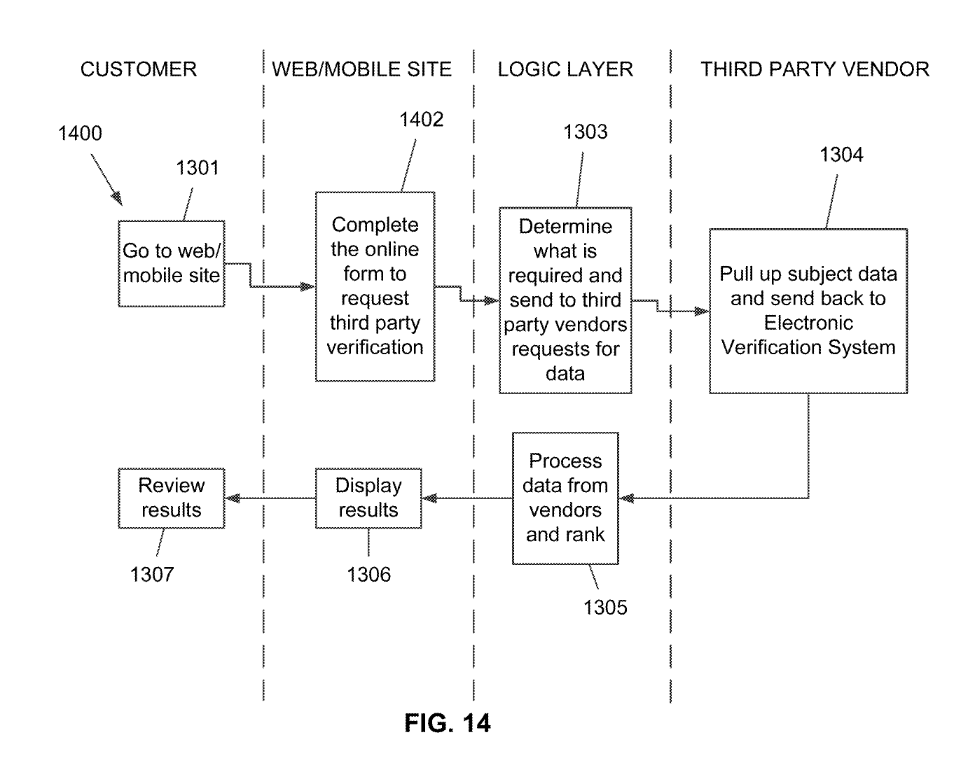

In one or more embodiments there are different levels of verification. For instance, basic verification requires partial social security number (SSN) and no driver's license, whereas a premium verification requires both a full SSN and driver's license number. Verification can also be performed for the user (e.g., FIG. 13) or requested for a third party (e.g. FIG. 14).

FIG. 13 shows an example method 1300 for self-verification. It involves a customer going to a website (or mobile site) 1301 and completing an online form (e.g. answering identification questions about the user) and submitting the online form with payment 1302. For instance the online form enables the user to register on the platform, login to the system, and access a main menu of the electronic verification system, and get certified. The electronic verification system may determine what is required (e.g., to get certified) and send to third party vendors requests for data. The third party venders will pull the subject data and send back to the electronic verification system 1304. The electronic verification system processes the data from the vendors and ranks the data in one or more embodiments 1305. For instance, the data may be weighted (e.g., by age) for verification methods according to embodiments herein. The results of the verification can be displayed on a web site or mobile site 1306 for the customer to review the results 1307.

FIG. 14 shows an example method 1400 for requesting a verification for a third party. The process can be similar to the method 1300 except that instead of completing an online form for oneself, a form is completed to request third party verification.

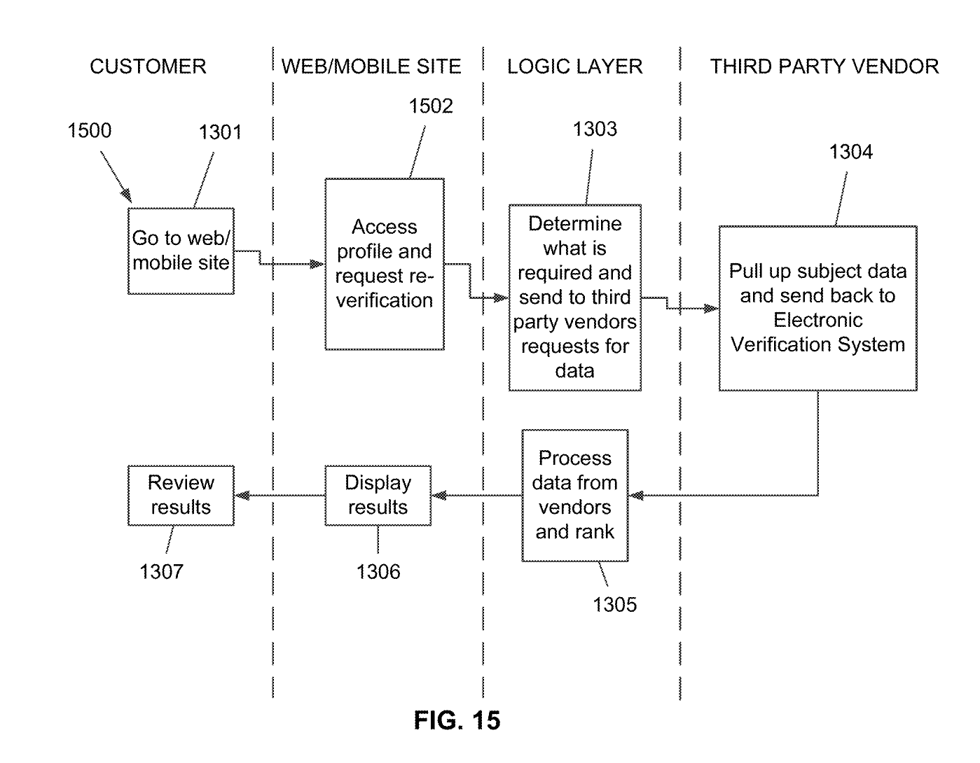

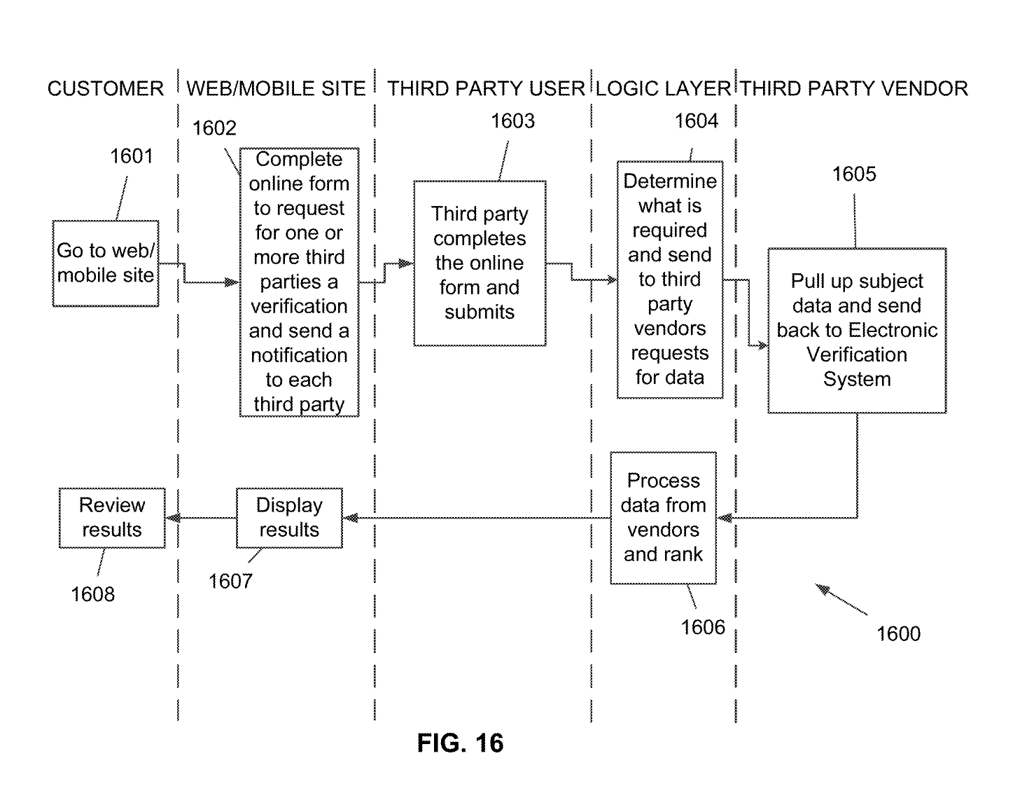

The electronic verification system in accordance with FIG. 13 or FIG. 14 in one or more embodiments further determines if verification is one-time or a refresh. If one-time, it uses verification criteria as described herein and stores a score result. If refresh, it uses credibility criteria as described herein and stores score results. The method further comprises in one or more embodiments refreshing (e.g., monthly or on-demand) and storing trend data. For example, FIG. 15 shows an example method 1500 for reapplying for verification on-demand for oneself. Method 1500 is very similar to the methods 1300 and 1400 except that since a profile is already created, a user in step 1502 simply has to access the profile and request re-verification rather than filling out an online form again. FIG. 16 shows an example method 1600 for sending a verification request to one or more third parties. The method comprises the customer going to a website (or mobile site) in step 1601. Completing an online form to request one or more third parties a verification and sending a notification (e.g., an e-mail) to each third party in step 1602. The third party in response to the notification completes an online form and submits it to the electronic verification system 1603 (e.g., in accordance with method 1400). The electronic verification system at a logic layer determines what is required to complete the verification and sends to third party venders request for data 1604. The third party vendors pull the requested data and send it back to the electronic verification system 1605. The electronic verification system processes the data from the vendors and ranks the data in one or more embodiments 1606. For instance, the data may be weighted (e.g., by age) for verification methods according to embodiments herein. The results of the verification can be displayed on a web site or mobile site 1607 for the customer to review the results 1608. More than one verification request can be sent to multiple third parties (e.g. via a batch verification request).

The electronic verification system in one or more embodiments determines the level of verification (e.g., if the verification is basic or premium as described above). This can control the amount or degree of requests for third party venders. For example if it is a basic verification, the system does not include a check for full SSN match, or driver's license verification in its requests for third party venders.

In one or more embodiments, the electronic verification system accepts personal identifying information, government, and social login information supplied by subject (including age) and retrieves, aggregates and logs data from one or more sources.

In one or more embodiments, the electronic verification system calculates a verification score for the user (self) or a third party and stores. For example, the verification criteria includes, as described in more detail above, one or more of determining if the first five characters of SSN and City of Birth Information is a match or for premium, if full match on SSN and driver's license number; checking how many instant identity questions and answer questions are answered successfully; calculating average social media profile and electronic verification age; calculating number of Facebook friends and number of LinkedIn connections and number of electronic verification activities logged within 30 days; checking lifestyle indicators; online reputation; and national crime and sex offender status.

In one or more embodiments, the electronic verification system calculates a credibility score (e.g. monthly or on-demand) and stores. For example, the credibility criteria includes, as described in more detail above, one or more of determining if first five characters of SSN and City of Birth Information is a match or for premium, if full match on SSN and DL number; checking how many instant identity questions and answer questions are answered successfully; calculating found on social networks and electronic verification system activity; calculating average social media profile and electronic verification system age; calculating age of credit data; calculating number of Facebook friends, number of LinkedIn connections, and number of electronic verification system activities within 30 days; checking if verified Facebook user; lifestyle indicators; online reputation; and national crime and sex offender status.

In one or more embodiments, a user of the electronic verification system can, via the system, apply for certifications (for itself or a third party); reapply for verification; purchase a third party verification request; purchase a batch verification request; access verification activity; respond to a third party verification request; convert to a primary (e.g., monthly) subscriber; connect to social media accounts; log an activity; request an activity code (e.g., QR codes); profile management; perform activity management; browse and discover other users; view a dashboard (e.g. one that includes credibility or verification results plus activity) (e.g., as shown in FIG. 3); perform verification inquiry; and cancel a subscription. In the same or different embodiments, the profile management and activity management include create, update, deleting operations (CRUD ops) for a profile or activity, respectively.

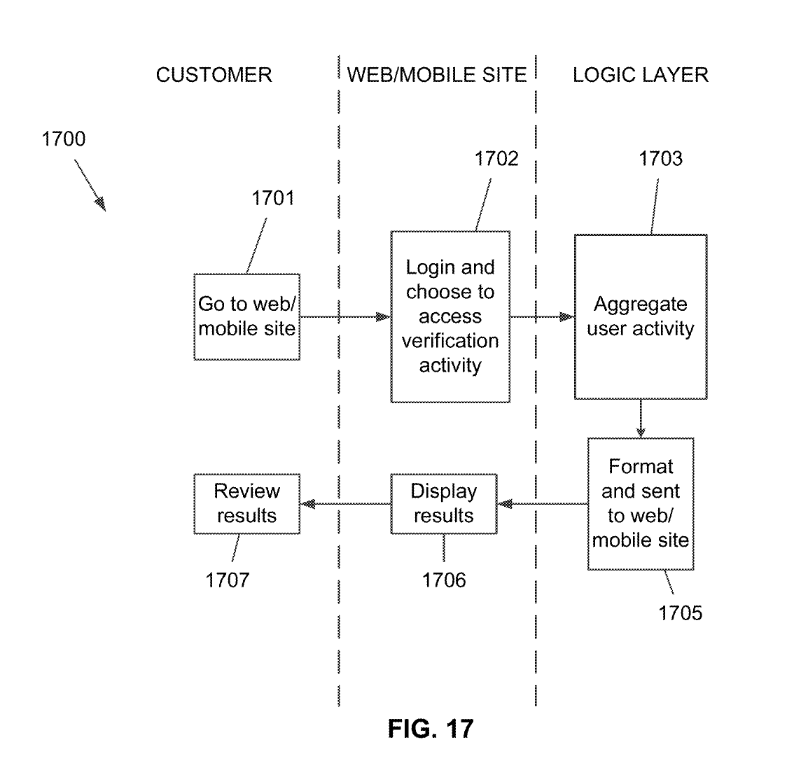

For instance, FIG. 17 shows a method 1700 for accessing verification activity. The user or customer would go to a website (or mobile site) 1701. The user would login and choose to access verification activity 1702 via the website (or mobile site). The electronic verification system would aggregate user activity and format to send back to web (or mobile site) 1705. The electronic verification system would display the results 1706 and the customer could review the results 1707.

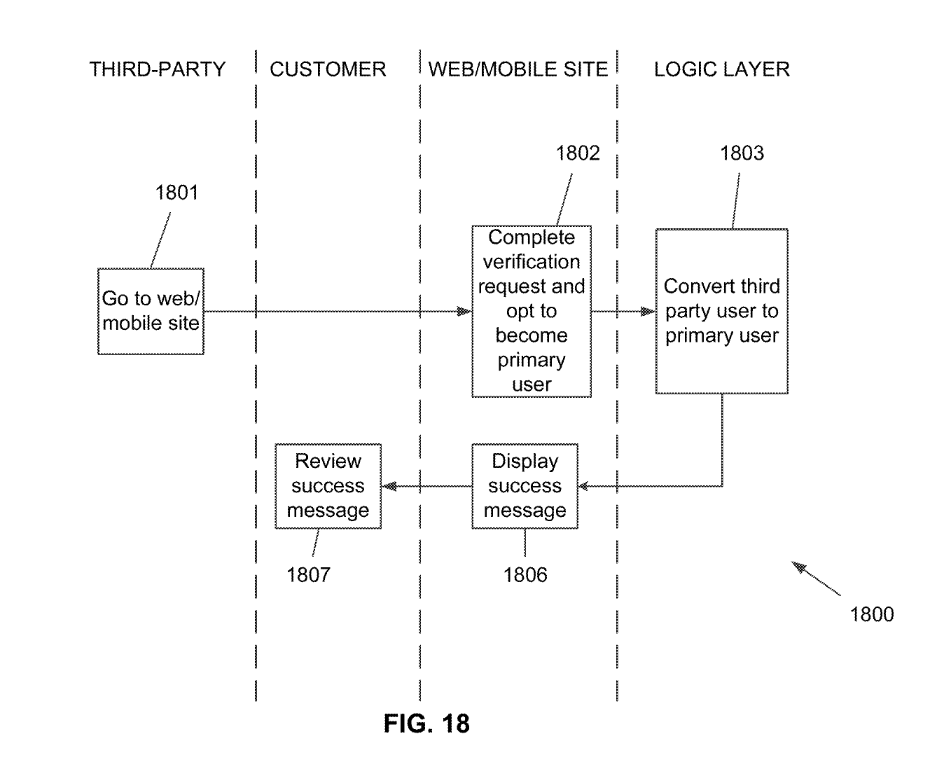

FIG. 18 shows a method 1800 for a third party who receives a verification request to convert to a primary user (e.g., create a profile in the electronic verification system and pay a monthly fee). The method comprises going to a web (or mobile) site 1801. When the user completes the verification request the user can opt to become a primary user 1802. The electronic verification system converts the third party user to a primary user 1803; the electronic verification system will display a success message via the web (or mobile) site 1806. The now customer can review the success message 1807.

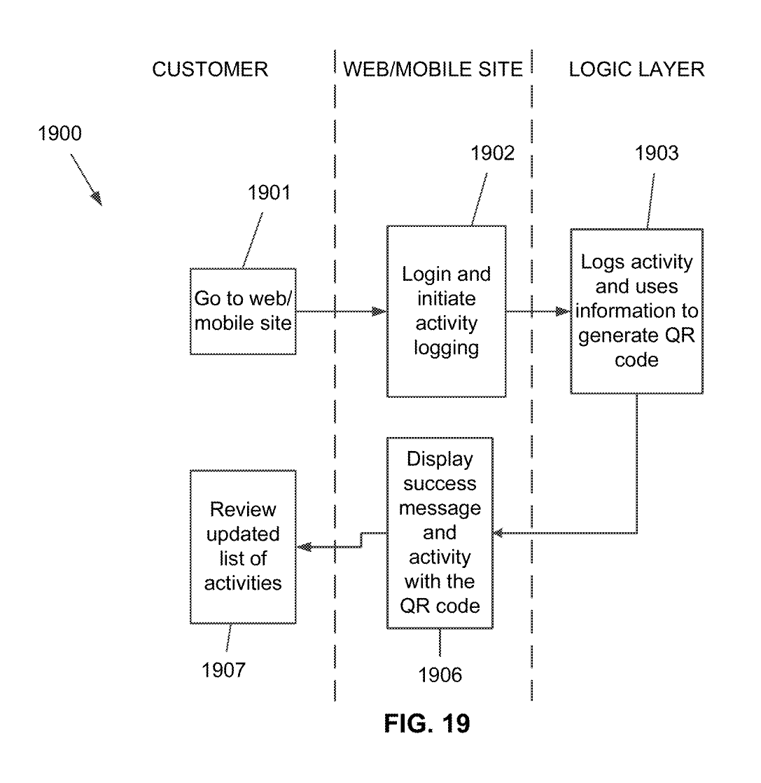

FIG. 19 shows a method 1900 for a customer to request an activity code (e.g., for generating a QR code to place with an advertisement). The customer goes to the web (or mobile) site 1901. The user logs in and initiates activity logging via the web (or mobile) site 1902. The electronic verification system at a logic layer logs activity and uses information (e.g., profile information) to generate QR code 1903. The web (or mobile site) displays a success message and activity with the QR code 1906 (e.g., for pasting into an electronic advertisement). The customer reviews the update list of activities 1907.

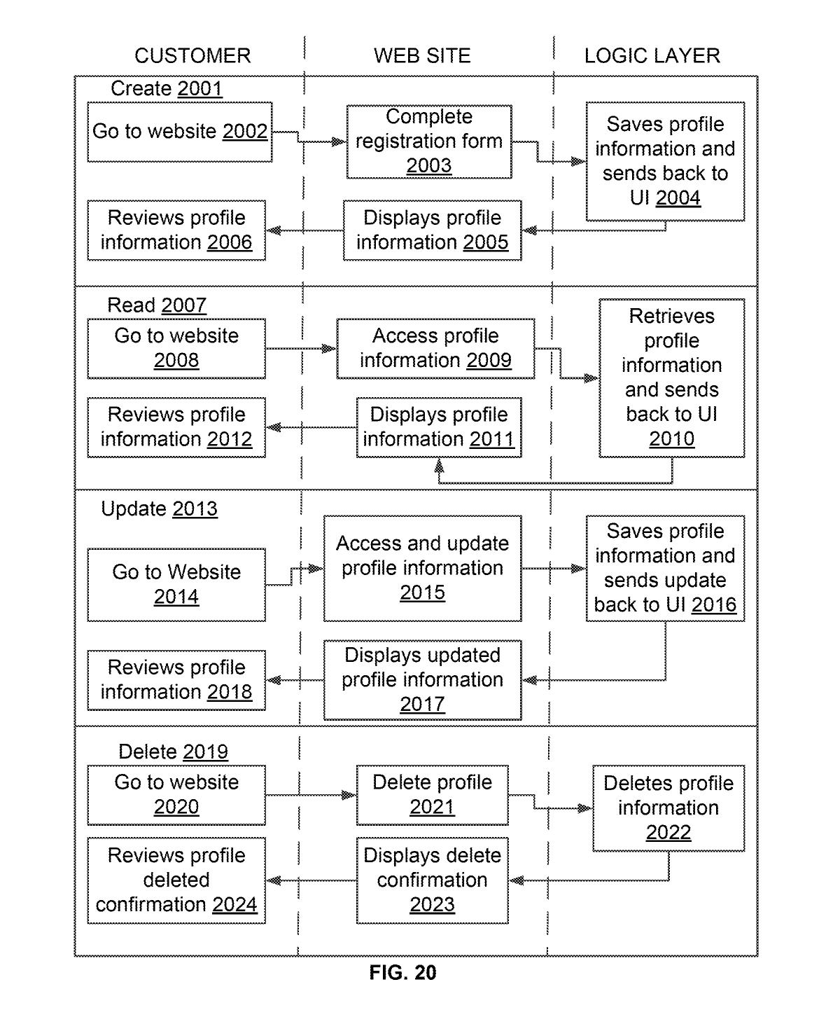

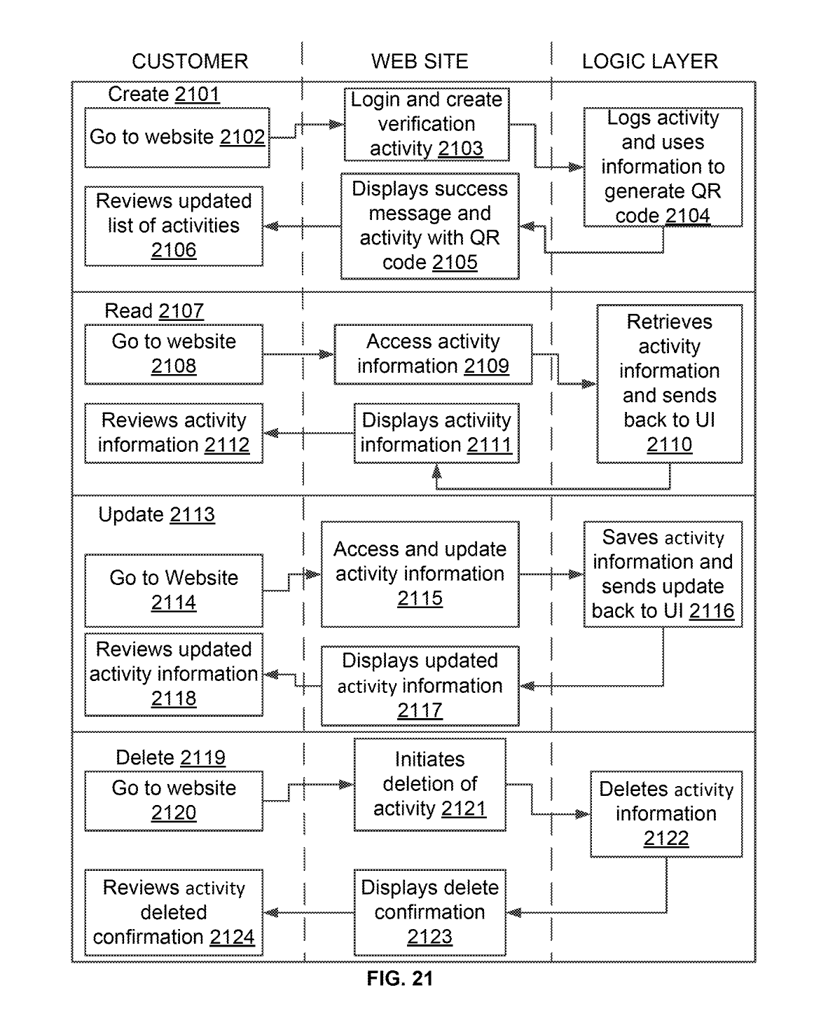

FIG. 20 shows various methods 2001, 2007, 2013, and 2019 for a customer to engage in profile management via the electronic verification system and FIG. 21 shows various methods 2101, 2107, 2113, and 2119 for a customer to engage in activity management via the electronic verification system. Both managements provide for creating reading updating or deleting the respective profile or activity. The processes are described with references to a website but it could also be a mobile site.

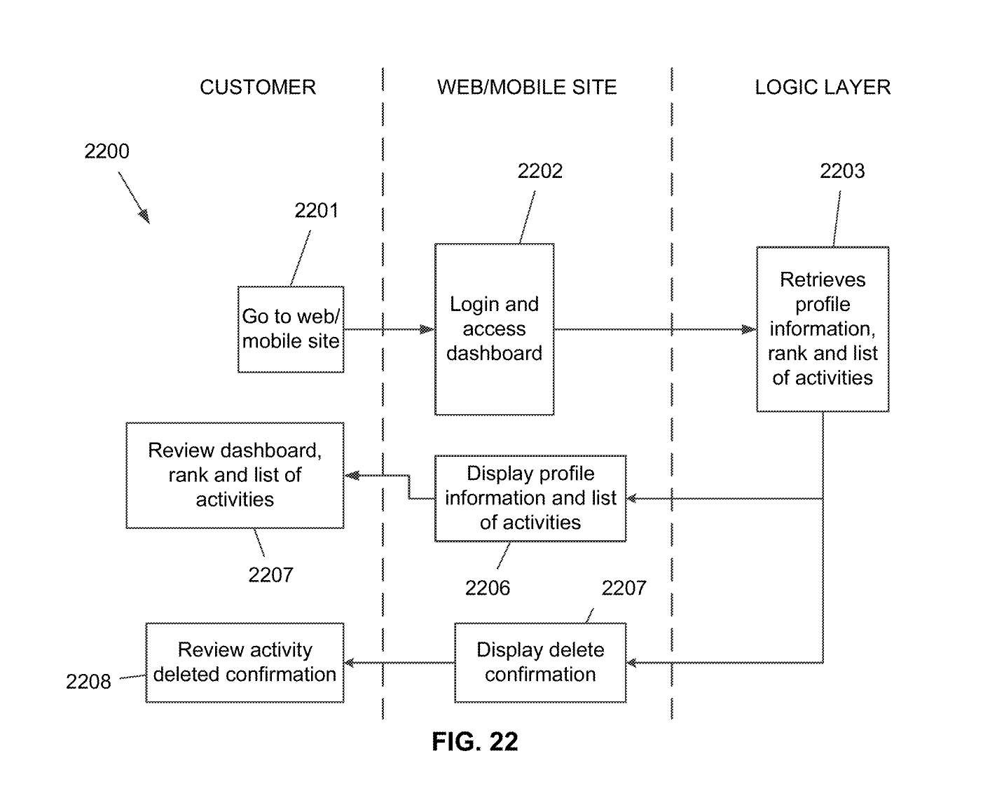

FIG. 22 shows method 2200 for viewing or deleting dashboard results and activity. The customer goes to the web (or mobile) site 2201. The user logs in and accesses a dashboard via the web (or mobile site) 2202. The electronic verification system at a logic layer retrieves profile information, rank and list of activities 2203. The method can be used to display profile and activities 2206 for the customer to review 2207 or it can be used to delete profiles and activities. In this case the web (or mobile) site will display a delete confirmation 2207, which the customer can review 2208.

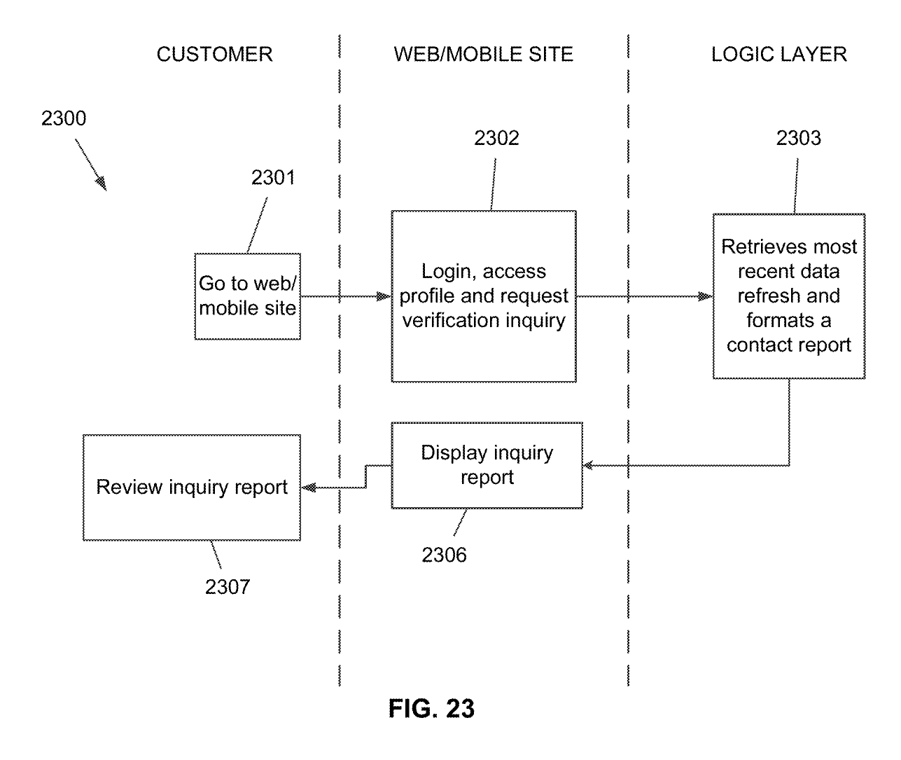

FIG. 23 shows a method 2300 for performing a verification inquiry. The customer goes to the web (or mobile) site 2301. Via the web (or mobile) site, the customer can login, access profile and request verification inquiry 2302. The electronic verification system at a logic layer retrieves the most recent data, refreshes the data, and formats a contact report 2303. The web (or mobile site) can then display the inquiry report 2306 for the customer to review 2307. Of course, the user can instead delete the verification results rather than display the inquiry report.

In one or more embodiments, a user of the electronic verification system registers on the platform (e.g., via a sign up screen of a web site or mobile site). In the same or different embodiments, the user logs into the system (e.g., via a login screen). The login screen uses a custom login or other social media or e-mail login (e.g. Facebook login or email address). There can be a ‘forgot password’ screen for if the user forgets a password to log into the electronic verification system. In the same or different embodiments, the user accesses a main menu (e.g., a main dashboard). For new users (who have never been certified) the main menu displays the option to 1) get certified or 2) manage profile. For existing users, the main menu displays most recent verification result (gauge), and options to 1) re-certify, 2) buy a 3rd party certification, 3) manage activity 4) manage profile 5) manage billing. For users responding to a certification, the main menu will display a ‘get started’ button.

In one or more embodiments, a user of the electronic verification system gets certified for the user's self or a third party. In the same or different embodiments, the user selects a certification level (e.g., basic or premium as described herein) and the electronic verification system will process a payment (e.g., displays option to use card on file, or add a card to profile to pay for one-time certification or monthly subscription). If the user has selected basic certification, the electronic verification system will ask the user to tell the system more about the user (e.g. the electronic verification system will request partial social and no driver's license). If the user has selected premium certification, the electronic verification system will ask the user to tell the system more about the user (e.g., the system will request full social and driver's license). In the same or different embodiments, the user will provide social media profile information (e.g., the system allows the user to either enter their social media handles or connect directly via api). In the same or different embodiments, the user will complete identity question and answers (e.g., embed screen to lexis nexis identity question and answers). In the same or different embodiments, the electronic verification system will display results (e.g., display gauge with result based on verification or credibility score plus information that explains how score is derived and what to do in case of dispute). In the same or different embodiments, the user will reapply for verification (e.g., get certified). In the same or different embodiments, the user will purchase a 3rd party verification request including enter name and email address of subject (displays single entry screen plus option to enter multiple requests) and confirm purchase. If purchase is successful, the electronic verification system displays confirmation that customer will receive an invitation to accept the verification. In the same or different embodiments, the user purchases a batch verification request. For example, the user enters names and email addresses (gives option to enter one per line or upload a spreadsheet) and there will be a way for the user to see a successful upload of a spreadsheet and confirm purchase. If the purchase is successful, the electronic verification system displays confirmation that customer will receive an invitation to accept the verification.

In one or more embodiments, the electronic verification system allows access to verification activity, third party verifications (allows for string search of verifications), viewing or editing third party verification (e.g., allows editing of email address and re-sending the request); respond to third party verifications; third party certification (e.g., these certifications are always basic); or request information about user (e.g., will request partial social and no driver's license).

In the same or different embodiments, the electronic verification system provides social media profile information (e.g., allows user to either enter their social media handles or connect directly via api); connects social media accounts; selects social media account to connect (allows one at a time connection to facebook, linkedin and twitter, and requires user to be logged into account to be connected); confirms connection to social media account; displays successful connection to social media account.

In the same or different embodiments, the electronic verification system allows the user to complete identity question and answers (e.g., embed screen to lexis nexis identity question and answers); displays results (displays gauge with result based on score plus information that explains how score is derived, what to do in case of dispute, and call-to-action to become a monthly subscriber); converts user to a monthly subscriber (this can actually apply to any one (e.g., primary or third party user); confirms subscription purchase (e.g., advises card will be charged if last certification greater than 30 days old; otherwise card will be charged at 30-day point); processes payments (displays option to use card on file, or add a card to profile to pay for one-time certification or monthly subscription; important that this happens before we pull data)

In the same or different embodiments, the electronic verification system allows for logging an activity; entering a new activity (includes selecting a social network, entering unique value for activity, date/time information); requesting an activity code (e.g. for a QR code); displaying generated QR code with instructions for downloading image (e.g., filename should indicate which activity the file is for, and include an activity identity)

In the same or different embodiments, the electronic verification system allows for profile management including displaying a profile screen (e.g., displays user photo, name, and verification status and basic profile information). When an activity QR code is scanned, the verification status and specific activity scanned is displayed.

In the same or different embodiments, the electronic verification system allows for activity management. For instance, the electronic verification system displays a list of activities (e.g., on basic profile screen in reverse chronological order and includes search capability)

In the same or different embodiments, the electronic verification system allows browse and discovery of other users. In some embodiments, it may be preferred to not have this capability (e.g., when it is preferred that users not be able to search for people they do not have a direct connection to or for whom they have not encountered an advertisement or profile, etc.).

In the same or different embodiments, the electronic verification system displays a dashboard, including one or more of a verification and/or credibility results; user activities, user basic profile; links to access other functionality in the electronic verification system.

In the same or different embodiments, the electronic verification system allows verification inquiry, including listing verifications (e.g., a list of all historic verifications with links to information details).

In the same or different embodiments, the electronic verification system allows for canceling subscription including asking a user to supply a reason for cancellation before allowing account to be cancelled.

Embodiments of the present disclosure may be carried out in other specific ways than those herein set forth without departing from the scope and essential characteristics of the invention. The present embodiments are, therefore, to be considered in all respects as illustrative and not restrictive.

What is claimed is:

1. A method implemented by an electronic verification system for verifying that an advertisement to engage in an activity is placed by a particular validated user whose identity is validated, the method comprising the electronic verification system:
receiving information that describes an advertisement to engage in an activity and that indicates when the particular validated user has or will place that advertisement;
creating referral information configured to be published in conjunction with the advertisement and to direct an advertisee to an electronic log of one or more advertisements placed by the particular validated user;
generating the electronic log to indicate when the particular validated user has or will place the advertisement described by the received information; and
publishing the electronic log to be accessible in accordance with the referral information.

2. The method of claim 1, wherein the advertisement is an advertisement to engage in an activity in person with the particular validated user.

3. The method of any of claim 1, wherein the advertisement is an advertisement to engage in a financial transaction in person with the particular validated user.

4. The method of any of claim 1, wherein the advertisement is an advertisement to engage in a social activity in person with the particular validated user.

5. The method of any of claim 1, wherein the advertisement is an online advertisement.

6. The method of any of claim 1, wherein the received information indicates a location where the particular validated user has or will place the advertisement.

7. The method of any of claim 1, wherein said creating comprises creating the referral information based on at least some of the received information.

8. The method of any of claim 1, wherein the referral information comprises a Quick Response (QR) code.

9. The method of any of claim 1, wherein the referral information comprises a uniform resource locator (URL).

10. The method of any of claim 1, further comprising establishing a degree to which the particular validated user is credible, and associating that degree with the generated electronic log.

11. The method of claim 10, further comprising receiving information indicating one or more online activities of the particular validated user and establishing the degree to which the particular validated user is credible based on the indications indicating the one or more online activities.

12. The method of any of claim 10, wherein establishing the degree to which the particular validated user is credible comprises determining a quantitative credibility score based on weighting a plurality of factors.

13. The method of claim 12, wherein the plurality of factors include how long and/or an extent to which the particular validated user has previously engaged in certain online activities.

14. The method of any of claim 12, wherein the plurality of factors include an extent to which the particular validated user is socially connected.

15. The method of any of claim 12, wherein the plurality of factors include an extent to which the particular validated user has a criminal history.

16. The method any of claim 12, wherein the plurality of factors are weighted differently depending on an age of the particular validated user.

17. An electronic verification system for verifying that an advertisement to engage in an activity is placed by a particular validated user whose identity is validated, the electronic verification system comprising:
a communication interface circuit configured to receive information that describes an advertisement to engage in an activity and that indicates when the particular validated user has or will place that advertisement;
one or more processing circuits configured to:
create referral information configured to be published in conjunction with the advertisement and to direct an advertisee to an electronic log of one or more advertisements placed by the particular validated user;
generate the electronic log to indicate when the particular validated user has or will place the advertisement described by the received information; and
publish the electronic log to be accessible in accordance with the referral information.

18. The electronic verification system of claim 17, wherein the advertisement is an advertisement to engage in an activity in person with the particular validated user.

19. The electronic verification system of any of claim 17, wherein the advertisement is an advertisement to engage in a financial transaction in person with the particular validated user.

20. The electronic verification system of any of claim 17, wherein the advertisement is an advertisement to engage in a social activity in person with the particular validated user.

21. The electronic verification system of any of claim 17, wherein the advertisement is an online advertisement.

22. The electronic verification system of any of claim 17, wherein the received information indicates a location where the particular validated user has or will place the advertisement.

23. The electronic verification system of any of claim 17, wherein the one or more processing circuits are configured to create the referral information based on at least some of the received information.

24. The electronic verification system of any of claim 17, wherein the referral information comprises a Quick Response (QR) code.

25. The electronic verification system of any of claim 17, wherein the referral information comprises a uniform resource locator (URL).

26. The electronic verification system of any of claim 17, wherein the one or more processing circuits are configured to establish a degree to which the particular validated user is credible, and associate that degree with the generated electronic log.

27. The electronic verification system of claim 26, wherein the communication interface circuit is configured to receive information indicating one or more online activities of the particular validated user, and wherein the one or more processing circuits are configured to establish the degree to which the particular validated user is credible based on the indications indicating the one or more online activities.

28. The electronic verification system of any of claim 26, wherein the one or more processing circuits are configured to establish the degree to which the particular validated user is credible by determining a quantitative credibility score based on weighting a plurality of factors.

29. The electronic verification system of claim 28, wherein the plurality of factors include how long and/or an extent to which the particular validated user has previously engaged in certain online activities.

30. The electronic verification system of any of claim 28, wherein the plurality of factors include an extent to which the particular validated user is socially connected.

31. The electronic verification system of any of claim 28, wherein the plurality of factors include an extent to which the particular validated user has a criminal history.

32. The electronic verification system of any of claim 28, wherein the plurality of factors are weighted differently depending on an age of the particular validated user.

33. A computer program product stored on a non-transitory computer readable medium and comprising computer program code that, when executed by an electronic verification system, verifies that an advertisement to engage in an activity is placed by a particular validated user whose identity is validated, wherein the computer program code configures the electronic verification system to:
receive information that describes an advertisement to engage in an activity and that indicates when the particular validated user has or will place that advertisement;
create referral information configured to be published in conjunction with the advertisement and to direct an advertisee to an electronic log of one or more advertisements placed by the particular validated user;
generate the electronic log to indicate when the particular validated user has or will place the advertisement described by the received information; and
publish the electronic log to be accessible in accordance with the referral information.
